(19) United States
(12) Patent Application Publication
(10) Pub. No.: US 2026/0202050 A1
(43) Pub. Date: Jul. 16, 2026

(54) FIREPROOF LIGHTING STRUCTURE WITH MESSAGE SENDING CAPABILITY

(71) Applicant: LEDVANCE LLC, WILMINGTON, MA (US)

(72) Inventors: Tianzheng Jiang, Shenzhen (CN); Ming Li, Acton, MA (US)

(21) Appl. No.: 19/446,277

(22) Filed: Jan. 12, 2026

Related U.S. Application Data
(60) Provisional application No. 63/743,804, filed on Jan. 10, 2025.

(51) Int. Cl. F21V 23/04; F21S 8/02; F21V 23/00; F21V 29/15; F21V 29/89; G08B 3/10; G08B 5/38; G08B 17/10; G08B 25/00; G08B 25/10; F21Y 115/10

(52) U.S. Cl. CPC F21V 23/0471; F21S 8/026; F21V 23/006; F21V 23/0407; F21V 29/15; F21V 29/89; G08B 3/10; G08B 5/38; G08B 17/10; G08B 25/007; G08B 25/10; F21Y 2115/10

(57) ABSTRACT

A lighting structure including a light engine contained within a housing, there the housing is comprised of a fire-retardant material. The lighting structure may further include a fire sensor assembly mounted within the housing, the fire sensor assembly comprising a sensor and a message sending device.

### CROSS REFERENCE TO RELATED APPLICATIONS

This application claims the benefit of U.S. Provisional Application No. 67/743,804 filed January 10, 2025 titled “Fireproof lighting structure with message sending capability”, which is incorporated herein in its entirety by reference.

### TECHNICAL FIELD

The present invention relates generally to lighting structures, and in particular embodiments, to lighting structures having characteristics suitable for minimizing fire damage.

### BACKGROUND

Downlight type lighting is typically installed into ceiling and/or roof spaces that can be at risk of compromising the susceptibility of the ceiling and/or roof space to be impacted by fire damage. Downlight type lighting is generally installed into an aperture in the ceiling that has to be relatively wide to accommodate the downlight assembly and therefore can compromises the ability of the ceiling to contain a fire in a room or even a fire caused by the light fitting itself failing. In order to compensate against these increased risks, some building codes can specify that downlight type lighting incorporate adaptations to improve their fire barrier capabilities.

### SUMMARY

In some embodiments, a lighting structure is provided that includes a light engine contained within a housing. In some embodiments, the housing is composed of a fire-retardant material, and a fire sensor assembly mounted within the housing. In some embodiments, the fire sensor assembly includes a sensor and a message sending device. In some embodiments, the housing has a downlight geometry. In some embodiments, the fire-retardant material includes stainless steel or cold rolled steel. In some embodiments, the fire-retardant material has a melting temperature that is greater than 1350°C. In some embodiments, the fire sensor assembly includes a base supporting substrate for supporting the sensor and the message sending device, and a cover positioned over the sensor and the message sending device. Examples of fire or smoke detection sensors suitable for use as the sensor integrated into the lighting structures of the present disclose can include dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof. In some embodiments, the messaging device comprises a WiFi transceiver, a cellular transceiver, a Zigbee transceiver, a Bluetooth transceiver or a combination thereof. In some embodiments, the lighting structure further include a local signal emitter mounted in the fire sensory assembly. In some embodiments, the local signal emitter comprises an audible sound or a visual que.

In one embodiment, a lighting structure is provided that includes a light engine contained within a housing. In some embodiments, the housing is composed of a fire-retardant material. In some embodiments, the lighting structure also includes a fire sensor mounted within the housing, and driver electronics electrically connected to the light engine, but separate from the housing. In some embodiments, the driver electronics include a message sending device. In some embodiments, the housing of the lighting structure has a downlight geometry. In some embodiments, the fire-retardant material of the lighting structure is composed of stainless steel or cold rolled steel. In some embodiments, the fire-retardant material of the lighting structure has a melting temperature that is greater than 1350°C. In some embodiments, the fire sensor assembly includes a base supporting substrate for supporting the sensor and the message sending device, and a cover positioned over the sensor and the message sending device. In some embodiments, the sensor of the fire sensor assembly is selected from the group consisting of fire or smoke detection sensors. Examples of sensors that can be integrated into the lighting structures of the present disclose can include dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof. In some embodiments, the messaging device includes a WiFi transceiver, a cellular transceiver, a Zigbee transceiver, a Bluetooth transceiver or a combination thereof. In some embodiments, the lighting device further includes a local signal emitter mounted in the fire sensory assembly. In some embodiments, the local signal emitter comprises an audible sound or a visual que.

In another embodiment, a method of lighting is provided that includes mounting a housing of fire-retardant material containing a light engine of a light structure to an opening in a ceiling, monitoring an environment under the ceiling with a sensor within the housing containing the light engine, and analyzing measurements from the sensor to detect fire. In some embodiments, the method further includes sending a message with a message device within the light structure to a user reporting the measurements from the sensor that detected the fire.

In another embodiment, a lighting structure is provided that includes a light engine contained within a housing, where the housing is comprised of a fire-retardant material; and a fire sensor assembly mounted within the housing, the fire sensor assembly comprising a sensor and a control unit, wherein the control unit reading sensor readings indicating a fire sends a signal to the light engine causing light emitted therefrom to flicker (e.g., flash on and off).

In yet another embodiment, a method of lighting is provided that include mounting a housing of fire-retardant material containing a light engine of a light structure to an opening in a ceiling, the light structure further including a sensor, a control unit and driver electronics, the driver electronics for controlling light emitted; monitoring an environment under the ceiling with the sensor within the housing containing the light engine; analyzing measurements from the sensor with the control unit to detect fire; and adjusting the light engine through the driver electronics to cause the light emitted from the light engine to flicker.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an exploded perspective view of a downlight constructed of fire-resistant materials, in accordance with some embodiments.

FIG. 2 is a perspective view illustrating a downlight constructed of fire-resistant materials that is installed into a ceiling, in accordance with some embodiments.

FIG. 3 is a top down view of a light engine for use in the light structure, in accordance with some embodiments.

FIG. 4 is a perspective view illustrating a downlight constructed of fire-resistant materials and further including a fire detect sensor that can be viewed by removing the lens from the downlight, in accordance with some embodiments.

FIG. 5 is a perspective exploded view of the downlight illustrated in FIG. 3, in which the fire detect sensor has been disconnected from its mount and the power wire that is positioned within the housing of the downlight, in accordance with some embodiments.

FIG. 6A is an exploded view of a fire detect sensor from the top case side of the detector, in accordance with an embodiment of the present disclosure.

FIG. 6B is an exploded view of a fire detect sensor from a backside of the detector, in accordance with an embodiment of the present disclosure.

FIG. 7A is an exploded view of a fire detect sensor including a WiFi communications transmitter from the top case side of the detector, in accordance with an embodiment of the present disclosure.

FIG. 7B is an exploded view of a fire detect sensor including a WiFi communications transmitter from the back side of the detector, in accordance with an embodiment of the present disclosure.

FIG. 8 is a perspective view of a downlight having a sensor and a driver, in accordance with an embodiment of the present disclosure.

FIG. 9A is an exploded view of a driver assembly from the upper face of the driver, in which the driver assembly includes a messaging device, in accordance with an embodiment of the present disclosure.

FIG. 9B is an exploded view of a driver assembly from the back face of the driver depicted in FIG. 9A, in accordance with an embodiment of the present disclosure.

FIG. 10A is an exploded view of a driver assembly from the upper face of the driver, in which the driver assembly does not include a messaging device, in accordance with an embodiment of the present disclosure.

FIG. 10B is an exploded view of a driver assembly from the back face of the driver depicted in FIG. 10A, in accordance with an embodiment of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

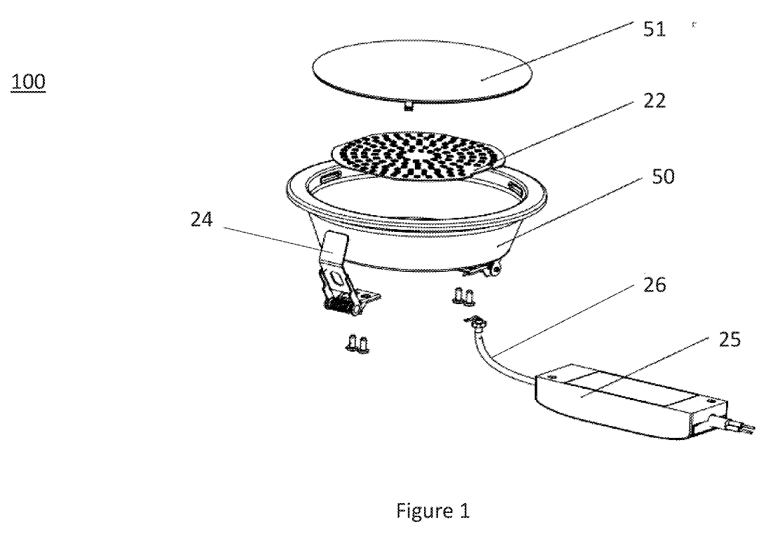

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Embodiments will now be discussed with respect to certain embodiments in which a fire sensor and communications module is integrated into a fireproof lighting structure including a light emitting diode light engine. The embodiments presented herein are intended to be illustrative and are not intended to limit the embodiments to the precise descriptions as discussed. Rather, the embodiments discussed may be incorporated into a wide variety of implementations, such as lighting structures including light emitting diode (LED) containing light engines in general, and all such implementations are fully intended to be included within the scope of the embodiments. The structures and methods that are provided herein are now described with more detail with reference to FIGS. 1-10B.

FIG. 1 is an exploded perspective view of a luminaire, e.g., downlight 100, constructed of fire-resistant materials, in accordance with some embodiments. For example, at least the housing 50 may be composed of a fire-resistant material. The housing 50 is the main body of the luminaire and is designed to withstand high temperatures and provide a fire barrier.

In some embodiments, the housing 50 may be composed of a fire-retardant material, such as cold rolled steel (SPCC) and/or stainless steel. In some embodiments, stainless steel may be used for the housing 50 in fireproofing applications. Stainless steel is suitable for fireproofing applications, because of the chromium content of stainless steel. Chromium reacts with oxygen creating a protective layer. The protective layer provided by the reaction of chromium and oxygen prevents oxygen from reaching the metal (e.g., stainless) of the housing 50 for the downlight, in which oxygen is needed for a fire to start and continue to burn. Some examples of stainless-steel compositions that can be used for the material of the housing 50 in the fireproof downlight 100 can include 304 grade stainless steel and/or 316 grade stainless steel.

The composition of 304 stainless steel is primarily iron, chromium, and nickel, with the following approximate percentages:

Iron: 66–75%

Chromium: 18–20%; and

Nickel: 8–10.5%.

Other elements in 304 stainless steel include:

Manganese (Mn) ≤ 2%

Silicon (Si) ≤ 0.75%

Nitrogen (N) ≤ 0.10%

Carbon (C) ≤ 0.08%

Phosphorus (P) ≤ 0.045%; and

Sulfur (S) ≤ 0.03%.

In some examples, the composition of stainless steel 316 includes 16–18% chromium, 10–14% nickel, 2–3% molybdenum, up to 2% manganese, up to 0.75% silicon, up to 0.10% nitrogen, up to 0.08% carbon, up to 0.045% phosphorus, up to 0.03% sulfur, with iron making up the remainder.

In some embodiments, 304 grade stainless steel has a higher temperature tolerance than 316-grade stainless steel. In some embodiments, stainless steel melts between 1399˚C to 1454˚C. In some embodiments, 316 stainless steel has a slightly lower temperature tolerance than 304-grade stainless steel, melting between 1371 ˚C to 1399˚C. Both grades can maintain their structural integrity in a fire.

According to another embodiment, the housing 50 is a made of a plurality of pieces that are assembled using, for example, a laser welding process with a fire-resistant welding material, such as stainless steel. According to still another embodiment, the housing 50 is made of another fire-retardant material such as ceramic.

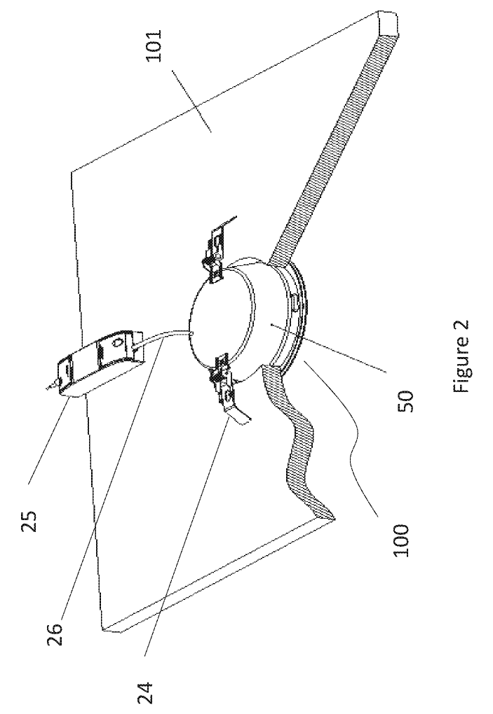

FIG. 2 is a perspective view illustrating a downlight 100 constructed of fire-resistant materials that is installed into a ceiling 101, in accordance with some embodiments. The downlight 100 may be installed into openings in the ceiling 101. In some embodiments, the downlight 100 may be secured to the ceiling by spring clips 24 connected to the housing 50 of the downlight 100.

In some embodiments, the geometry of the downlight 100 (including the housing 50) may be dimensioned to be available in various sizes based on the diameter of the circular opening where the downlight 100 is installed. In some examples, the circular opening of the downlight geometry light engine housing 50 may be sized in 6-inch and 8-inch diameter. It is noted that these dimensions are provided for illustrative purposes only and are not intended to limit the present disclosure. For example, the housing 50 may also have a circular opening in diameters equal to 2 inches, 3 inches, 4 inches or 5 inches. In some embodiments, the downlight geometry light engine housing 20 can also be “Air Tight”, which means it will not allow air to escape into the ceiling or attic, thus reducing both heating and cooling costs, as well as obstructing fire from being transmitted into the space behind the ceiling 101 from the underlying room.

When installed, the downlight 100 closes the opening in the ceiling 101. If a fire was to damage the structural integrity of the downlight 100 to the point that the downlight 100 could no longer remain installed in the opening in the ceiling 101, the opening to the ceiling may be exposed to the fire. For example, if the downlight 100 was to be removed from the opening, a fire within a room underlying the ceiling 101 could propagate through the opening in the ceiling, and then travel through the open space within the ceiling 101. That could cause the fire to spread to different rooms, and/or floors within the be building beyond the original room in which the fire started.

A downlight 100 constructed of fire-retardant and/or fire resistant and/or fireproof materials when subjected to flames and/or high temperatures can maintain structural integrity. More specifically, when subjected to flames or temperatures consistent with fire, a downlight 100 having a housing 50 composed of one of the aforementioned fireproof materials will not lose their structural integrity, and can remain installed in the ceiling 101, e.g., can remain installed within the openings in the ceiling 101. Because a downlight 100 constructed of fire retardant and/or fire resistant and/or fireproof materials remains installed within the opening of the ceiling 101, the downlight 100 when subjected to flames and/or high temperature can obstruct fire from spreading from a room in which the fire is present into ceiling passages, e.g., through the openings in the ceiling in which the downlights 100 have been installed.

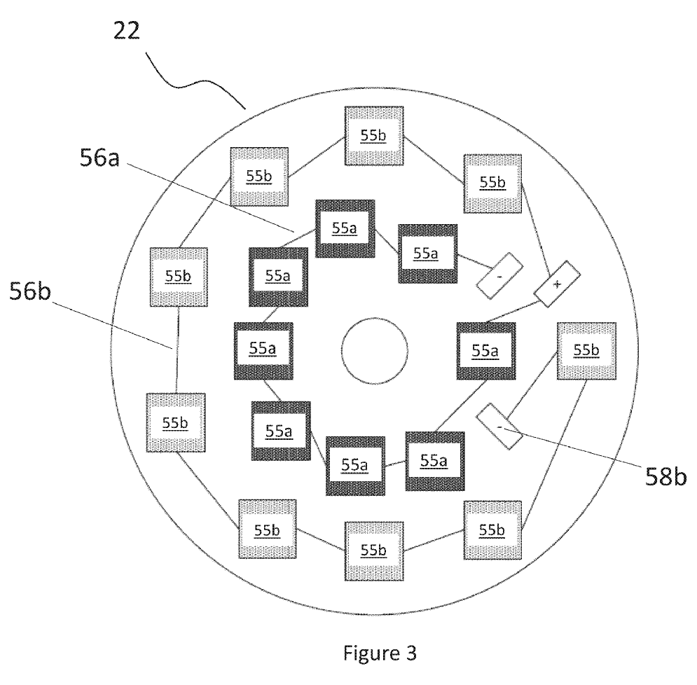

Referring back to FIG. 1, the downlight 100 may further include a lens-cover 51, and a light engine 22. FIG. 3 illustrates a light engine 22 in accordance with one embodiment of the present disclosure. The light engine 22 (also referred to as light source) is positioned within the light engine housing 50 having the downlight geometry and is orientated to emit light in a direction through the light emitting end of the housing 50. The light engine 22 produces light from solid state emitters. The term “solid state” refers to light emitted by solid-state electroluminescence, as opposed to incandescent bulbs (which use thermal radiation) or fluorescent tubes, which use a low-pressure Hg discharge. Compared to incandescent lighting, solid state lighting creates visible light with reduced heat generation and less energy dissipation. Some examples of solid-state light emitters that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid-state light emitters are provided by light emitting diodes, any of the aforementioned solid-state light emitters may be substituted for the LEDs.

In some embodiments, the light source (also referred to as light engine 22) is provided by a plurality of LEDs 55a, 55b that can be mounted to the circuit board by solder, a snap-fit connection, or other engagement mechanisms. In some examples, the LEDs 55a, 55b are provided by a plurality of surface mount device (SMD) light emitting diodes (LED). The circuit board for the light engine may be composed of a metal core printed circuit board (MCPB). MCPCB uses a thermally conductive dielectric layer to bond circuit layer with base metal (Aluminum or Copper). In some embodiments, the MCPCB use either Al or Cu or a mixture of special alloys as the base material to conduct heat away efficiently from the LEDs thereby keeping them cool to maintain high efficacy.

It is noted that the number of LEDs 55a, 55b on the printed circuit board may vary. For example, the number of LEDs 55a, 55b may range from 5 LEDs to 70 LEDs. In another example, the number of LEDs may range from 35 LEDs to 45 LEDs. It is noted that the above examples are provided for illustrative purposes only and are not intended to limit the present disclosure, as any number of LEDs may be present the printed circuit board. In some other examples, the number of LEDs 55a, 55b may be equal to 5, 10, 15, 20, 25, 30, 35, 40, 45, 50, 55, 60, 65 and 70, as well as any range of LEDs with one of the aforementioned examples as a lower limit to the range, and one of the aforementioned examples as an upper limit to the range.

The LEDs 55a, 55b may be arranged as strings on the printed circuit board. When referring to a “string” of LEDs it is meant that each of the LEDs in the string 56a, 56b are illuminated at the same time in response to an energizing act, such as the application of electricity from the driving electronics, e.g., driver, in the lamp. In the embodiment depicted in FIG. 3, the light engine 22 includes two strings 56a, 56b.

It is noted that the strings of LEDs 56a, 56b depicted in FIG. 3 is only one example of an LED configuration for a light engine 22. The present disclosure is not limited to only this example. For example, the light engine 22 may also employ light emitting diodes that are arranged on a filament type substrate. LED filaments are equally applicable for providing the LEDs of the light engine 22.

The lamp structure and methods of the present disclosure employ light engines having at least one light scheme, e.g., a plurality of light schemes, that are modulated to provide different light characteristics for the light being emitted by the light engine 22. A “light scheme”' is a grouping of lights, e.g., an LED string 56a, 56b, in which the lighting scheme provides that the LEDs 55a, 55b in the light scheme when illuminated provide a specific lighting characteristic, e.g., a specific value for one of color, color correlated temperature or intensity. By providing multiple lighting schemes each having different associated light characteristics and controlling the amount of current being directed to each of the different lighting schemes, the collective light characteristics for the totality of light schemes emitting light for the light engine 22 may be adjusted.

In one embodiment, the light engine 22 may be composed of multiple strings, e.g., two strings 56a, 56b, of LEDs 55a, 55b, in which each string 56a, 56b of LEDs 55a, 55b can provide a separate lighting scheme. In another example, each LED filament in the light engine 22 can provide a different LED lighting scheme.

In one embodiment, each scheme of LEDs may be illuminated to provide an intensity of light emitted by the light engine 22 for the lamp 100 that can range from 300 lumens (LM) to 1500 lumens (LM). As noted, each scheme of LEDs 55a, 55b may be selected to provide a different value of lumens when the LED string 56a, 56b is illuminated. For example, an integrated circuit (IC) can distribute current to each of the lighting scheme to mix the light being emitted by the lighting schemes. By mixing the light produced by the separate lighting scheme, the light characteristics of the light engine 22 may be a mixture of the light characteristics of the individual lighting schemes.

In some embodiments, each of the lighting schemes of the LEDs 55a, 55b of the light engine 22 may illuminated in mixtures provided by current distributions through a mixing integrated circuit of the driver electronics 25. In some embodiments, each of the lighting schemes of the LEDs 55a, 55b of the light engine 22 may illuminated in mixtures provided by current distributions through a mixing integrated circuit of the driver electronics 25 to provide an intensity of total light provided by the totality of lighting schemes that is equal to 350 lumens (LM) 500 lumens (LM), 550 lumens (LM), 700 lumens (LM), 750 lumens (LM), 1200 lumens (LM), 5000 lumens (LM), as well as any range of intensity values included one of the aforementioned values for the lower end of the range, and one of the aforementioned values for the upper end of the range, as well as individual values for intensity within those ranges. The intensity of the light emitted by the light engine 22 is a characteristic of light emitted by the lamp 100 that can be controlled by wireless controls.

In some embodiments, the LEDs 55a, 55b of the lamp 100 are selected to be capable of being adjusted for the color of the light they emit. The term “color” denotes a phenomenon of light or visual perception that can enable one to differentiate objects. Color may describe an aspect of the appearance of objects and light sources in terms of hue, brightness, and saturation. More specifically, in some embodiments, different lighting schemes, e.g., LED strings 56a, 56b, of LEDs 55a, 55b include different colors. For example, each lighting scheme includes an assigned color that is different from the other lighting schemes. For example, a first string of LEDs 56a may include LEDs 55a that emit blue light, and the second string of LEDs 56b may include LEDs 55b that emit red light.

Some examples of colors that may be suitable for use with the method of controlling lighting in accordance with the methods, structures and computer program products described herein can include red (R), orange (O), yellow (Y), green (G), blue (B), indigo (I), violet (V) and combinations thereof, as well as the numerous shades of the aforementioned families of colors. It is noted that the aforementioned colors are provided for illustrative purposes only and are not intended to limit the present disclosure as any distinguishable color may be suitable for the methods, systems and computer program products described herein.

The light engine 22 may also be adjusted to control color temperature. The color temperature of a light source is the temperature of an ideal black-body radiator that radiates light of a color comparable to that of the light source. Color correlated temperature is a characteristic of visible light that has applications in lighting, photography, videography, publishing, manufacturing, astrophysics, horticulture, and other fields. Color correlated temperature is meaningful for light sources that do in fact correspond somewhat closely to the radiation of some black body, i.e., those on a line from reddish/orange via yellow and more or less white to blueish white. Color correlated temperature is conventionally expressed in kelvins, using the symbol K, a unit of measure for absolute temperature. Color correlated temperatures over 5000 K are called “cool colors” (bluish white), while lower color temperatures (2700-3000 K) are called “warm colors” (yellowish white through red). “Warm” in this context is an analogy to radiated heat flux of traditional incandescent lighting rather than temperature. The spectral peak of warm-colored light is closer to infrared, and most natural warm-colored light sources emit significant infrared radiation. The LEDs of the luminaires provided by the present disclosure in some embodiments can range from 2000K to 6500K.

In some embodiments, each lighting scheme of LEDs 55a, 55b may be selected to provide a different value of color correlated temperature (CCT) when the LED string 56a, 56b is illuminated. The mixing integrated circuit (IC) can distribute current to each of the lighting schemes to mix the light being emitted by the lighting schemes. By mixing the light produced by the separate lighting schemes, the light characteristics of the light engine 22 may be a mixture of the light characteristics of the individual light schemes. For example, by mixing two light schemes of two different color correlated temperatures (CCT), the value for the color correlated temperature (CCT) for the total light being emitted by the light engine 22 may be a value between the two values specifically provided by the separate light schemes. The greater the current applied to a particular lighting scheme, the greater the contribution of the lighting characteristics for that particular lighting scheme is contributed to the lighting characteristics of the total light, e.g., total light spectra, being emitted by the light engine 22.

In some examples, each of the strings 56a, 56b of the LEDs 55a, 55b of the light engine 22 may illuminated in mixtures provided by current distributions through the mixing integrated circuit to provide a color correlated temperature of total light provided by the totality of lighting schemes that is equal to 2500K, 3000K, 3500K, 4000K, 5000K or 6500K, as well as any range of color correlated temperature (CCT) values including one of the aforementioned values for the lower end of the range, and one of the aforementioned values for the upper end of the range, as well as individual values for color correlated temperatures (CCT) within those ranges. The color correlated temperature (CCT) of the light emitted by the light engine 22 is a characteristic of light emitted by the light engine 22 that can be controlled by wireless controls. The light engine 22 is further depicted in FIGS. 1, 4, 5, and 8.

FIGS. 1, 4, 5 and 8 illustrate some embodiments of the lens 52. In some embodiments, the lens-cover 51 protect the light engine 22, in which the light engine 22 is present within the housing 50 and behind the light engine 22. In some embodiment, the lens 52 can help to focus or diffuse the light. Lens trim is designed to provide a diffused light. Lensed trims are normally found in wet locations. The luminous trims combine the diffused quality of lensed trim but with an open down light component. Adjustable trim allows for the adjustment of the light whether it is eyeball style, which protrudes from the trim or gimbal ring style, which adjusts inside the recess.

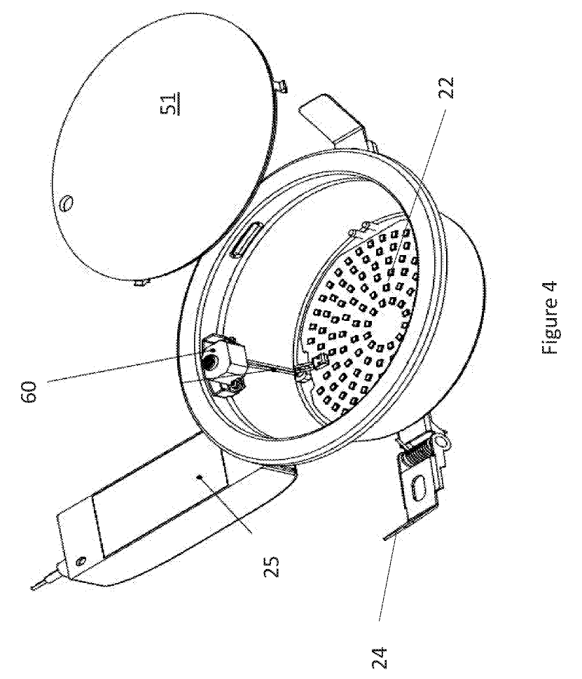

Referring to FIGS. 4, 5, 6A, 6B, 7A, and 8 in addition to providing a lighting structure, e.g., downlight 100, including a housing 50 composed of high melting point materials, such as metals (e.g., stainless steel) to block the spread of the flames and prevent fire; the lighting structures of the present disclosure may also include a sensor 60 for detecting fire. Examples of fire or smoke detection sensors suitable for use as the sensor 60 integrated into the lighting structures of the present disclose can include dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, and temperature sensors (e.g., negative temperature coefficient sensors).

In some embodiments, the sensor 60 may be a smoke detector. Smoke detectors use an optical or electrochemical sensor to detect smoke. The smoke detector may be an optical smoke detector, a photoelectric smoke detector and/or an ionic smoke detector.

An optical smoke detector is a device that detects smoke generated in a fire and is drawn into the detector. An optical smoke detector may employ light-emitting diodes (LEDs) to illuminate the surrounding area of a smoke chamber detector for analysis. The LEDs of the optical smoke detector are connected to a photodetector, typically a photodiode array or a single photodiode. The photodiode converts the reflected light into electricity, and the generated voltage is used to determine if there is smoke in the protected location.

Photoelectric smoke detectors also use light to detect smoke, but respond faster than optical detectors. Photoelectric smoke detector employ optical cameras to detect smoke. In some embodiments, the speed by which photoelectric smoke detectors react makes them ideal for areas where protection against fires that are expected to grow rapidly is needed, such as in kitchens.

Ionic (or ionization) smoke detectors are similar to photoelectric devices in that they respond quickly without relying on a complicated scanning mechanism. However, the sensors of ionic smoke detectors work by measuring ion levels in the surrounding air, not visible light as is analyzed in photoelectric smoke detectors or optical smoke detectors. This means that ionic detectors tend to be more effective for detecting fires where a large amount of smoke is not expected. Ionic smoke detectors may be suitable for use in chemical environments.

In some embodiments, the sensor 60 for detecting fire may be a temperature detector. Examples of temperature detectors that can be used for the sensor 60 integrated into the housing 50 of the lighting structure may include thermal detectors and thermovelocimetric detectors.

Thermal detectors may be used to detect high temperatures, activating an alarm signal once the predefined temperature threshold has been exceeded. In some embodiments, thermal detectors can employ a sensor element that includes platinum resistance thermometers (PRTs) or thermocouples, which detect temperature changes in a wire. Thermal detectors can be suitable for use in locations where high temperatures occur during normal activity or where there are sudden increases in temperature, such as in manufacturing environments employing ovens or kitchens.

Thermovelocimetric (TV) fire detectors are a type of smoke detector that uses a thermistor as the sensor element to detect a temperature rise that would signal that a fire has started. A thermistor is a semiconductor device whose electrical resistance varies with temperature. In some embodiments of thermovelocimetric (TV) fire detectors, a thermistor is placed in a stream of air and connected to an electronic circuit. The electronic circuit measures changes in voltage as the temperature of the air increases. When smoke enters the air stream, it absorbs heat and lowers its temperature. This causes a change in voltage measured by the thermovelocimeter detector circuit, which may activate a fire detection signal.

In some embodiments, the sensor 60 for detecting fire may be a flame detector. Examples of flame detectors that can be used for the sensor 60 integrated into the housing 50 of the lighting structure may include infrared flame detectors, ultraviolet flame detectors and flame detectors including combined infrared flame detecting elements and ultraviolet detecting elements. The flame detectors can be combined with smoke detectors to create a more effective fire detection system.

An infrared (IR) flame detector is a device that detects infrared radiation (heat) emitted by flames. Infrared flame detectors contain an emissive sensing element that converts infrared radiation into electrical output signals. Ultraviolet flame detectors use a combination of light sensors, filters, and photodetectors to detect the ultraviolet light emitted by flames. In an ultraviolet flame detector, a beam of light is directed through the area monitored by the detector and if an object blocks the light in any way, it will cause a break in the beam and trigger an alarm. The detector can also be used to detect smoke using an infrared filter that removes all visible light from the beam. Ultraviolet flame detectors can be suitable for use in areas with risk of fire or explosion, such as oil refineries, chemical plants and warehouses.

Combination Infrared and Ultraviolet Flame Detectors are a type of fire detector that uses ultraviolet and infrared light technology to detect the presence of flames. Combined infrared plus ultraviolet IR+UV flame detectors may be used in areas where there are sparks or flames, such as kitchens, bathrooms, garages, utility rooms and workshops.

In some embodiments, the sensor 60 for detecting fire may be linear infrared detectors. Linear infrared detectors (also referred to as “smoke or linear barriers”) are a type of detector that uses beams of infrared light to detect objects. The detector is made up of two parts: an emitter and a receiver. The emitter is a device that emits infrared rays, while the receiver detects the reflected rays. When an object obstructs the path between the emitter and the receiver, the light beam is interrupted. This interrupt is detected by the controller and used by the controller to trigger an alarm or other action.

In some embodiments, the sensor 60 for detecting fire may be a gas detector. Gas detectors can be used to detect the presence of combustible gases. Gas detectors can be designed to detect the presence of explosive and toxic gases. In one example, the gas detector may detect the presence of carbon monoxide (CO) gas. Gas detectors may be suitable for industrial applications, but are also becoming more common in residential applications.

Detector cable or temperature sensor for fire detection can be made up of two parts: a primary and a secondary conductor. The primary conductor may be composed of copper, while the secondary conductor may be composed of aluminum. The two conductors are separated by an insulator. There are two types of connection methods used for this type of detector: single pole and multipole connections.

It is noted that the above examples of sensors that can be used for the sensor 60 for detecting fire are provided for illustrative purposes only.

Referring to FIGS. 4, 5 and 8, in some embodiments, the sensor 60 for detecting fire is mounted within the housing 50 on the sidewall of the can portion of the downlight 100, in which the sensor 60 is positioned between the light engine 22 and the lens 51. In this embodiment, the sensor 60 is contained within the housing 50. In some embodiments, the sensor 60 is connected to the housing 50 with fasteners that reversibly engage the sensor 60 to the housing 50.

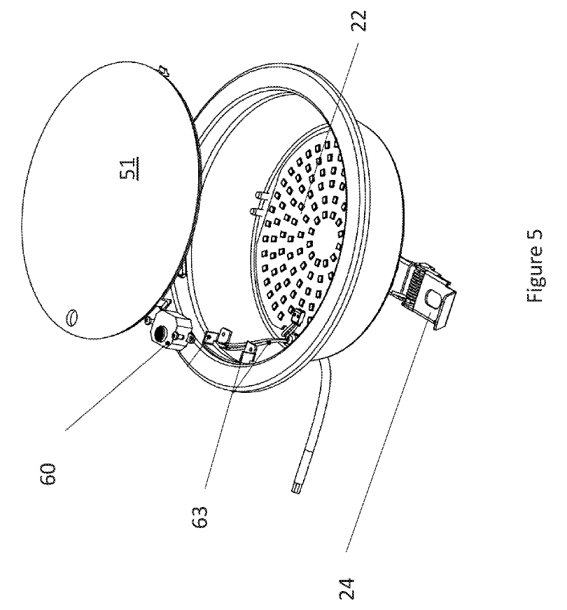

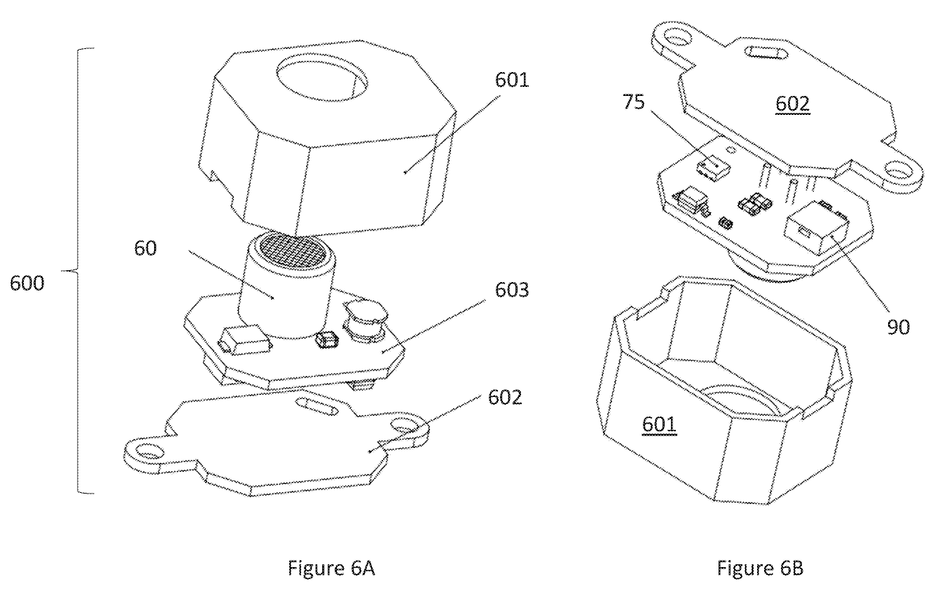

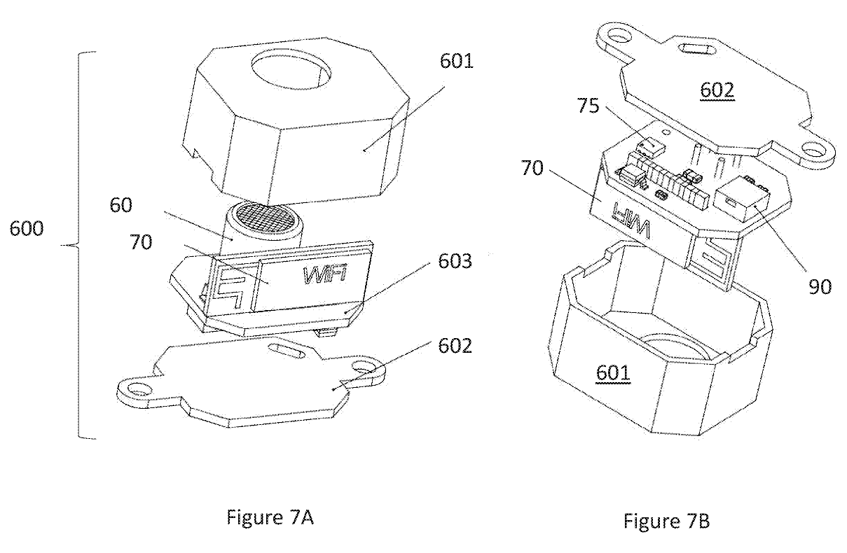

Referring to FIGS. 6A-7B, the sensor 60 may be integrated into a fire sensor assembly 600. The fire sensor assembly 600 may include a case 601, 602 that includes a base supporting substrate 602 for supporting the at least one of the sensors 60 and the message sending device 70, and a cover 601 positioned over the sensor 60 and the message sending device 70. The sensor 60 and the message sending device 70 may be mounted to a printed circuit board substrate 603. In some embodiments, the sensor assembly 600 is reversibly connected to the housing 50 for the light engine 22 by a bracket 63, as depicted in FIG. 5.

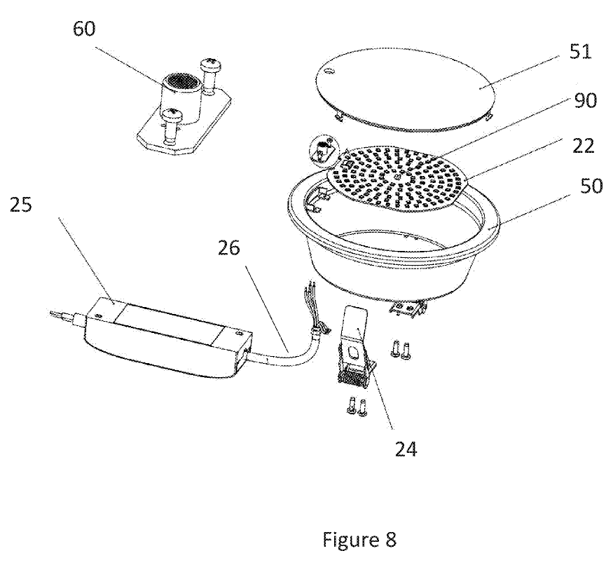

Referring to FIGS. 4, 5, 7A and 7B, in some embodiments, the sensor 60 is contained in a fire detection assembly 600 that includes the sensor 60 in combination with a messaging device 70. The messaging device 70 may send wireless communications including sensor data, such as the detection of a fire event. In some embodiments, in addition to the sensor 60 and the messaging device 70, the fire detection assembly 600 may include a local signal emitter 90, as depicted in FIGS. 6B, 7B and 8. The local signal emitter 90 may include a device that provides an audible sound or a visual que. The local signal emitter 90 may produce an audible alarm when the sensor 60 detects a fire event. For example, the local signal emitter 90 may include a buzzer. The local signal emitter 90 may produce a visual alarm when the sensor 60 detects a fire event. For example, the local signal emitter 90 may emit a light or a flashing light. It is noted that this is only one embodiment of the present disclosure, and it is not intended that the methods and structures be limited to only this example. For example, in some embodiments, the messaging device 70 may be omitted from the assembly that includes the sensor 60 for detecting fire, as illustrated in FIGS. 6A, 6B and 8. In even further embodiments, the local signal emitter 90 may be omitted as depicted in FIG. 8. In the embodiment that is depicted in FIG. 8, only the sensor 60 is present within the housing 50. In the embodiment that is illustrated in FIG. 8, the messaging device 70 may be integrated into the driver electronics 25 that are separate from the housing 50 for the downlight. In the embodiment depicted in FIG. 8, the local signal emitter 90 is integrated in the light engine 22.

The messaging device 70 may be a device for sending a communications signal, e.g., include a transmitter. However, the messaging device 70 may also receive communications signal, e.g., include a receiver. In some embodiments, the messaging device 70 is a transceiver, e.g., a combination transmitter and receiver, that both sends and receives communications signals. For example, the messaging device 70 may send communications signals that can send warning messages to users when a fire occurs. The methods and structures of the present disclosure, not only provide a means to stop the spread of a fire through a fire-resistant housing, but also includes the ability to sense that a fire has started and send a message to remote recipients that a fire has been detected.

The messaging device 70 may be a wireless control module that is based on IEEE 802.11, which stands for wireless LANs (WLANs), also known as Wi-Fi. For each of the above described standards, the messaging device 70 may employ a WiFi transmitter to access the internet. The WIFI wireless signal can be based upon IEEE 802.11, which is for wireless LANs (WLANs), also known as Wi-Fi. 802.11 is a family of specifications for wireless local area networks (WLANs) developed and maintained by a working group of the Institute of Electrical and Electronics Engineers (IEEE). The 802.11 is a wireless networking standard having technical specifications that govern the implementation of Wi-Fi networks for device compatibility and connectivity. Built into the 802.11 specification family are best practices, physical hardware-layer requirements and algorithms to address resource contention on shared networks. Each version of 802.11 spells out a theoretical performance limit, such as data throughput, signal range, network bandwidth and radio frequencies.

The earliest 802.11 iterations focused on improving speeds and data rates. The initial 802.11 spec specified operations in the 2.4 gigahertz (GHz) ISM band, with a top speed of about 2 megabits per second (Mbps), well below the gigabit-level data rates of a modern WLAN. With each technological advance, the amended specification has been identified by adding a suffix of one or two letters to the 802.11 nomenclature. Over time, the string of letters and numbers created confusion for enterprises trying to evaluate the capabilities of vendor products.

WLAN channels rely on networking equipment engineered for high performance. 802.11 deploys six half-duplex, over-the-air modulation techniques that share the same network protocol layer. 802.11 makes several radio frequencies that Wi-Fi devices use to communicate, including the 900-megahertz, 2.4 GHz, 3.6 GHz, 4.9 GHz, 5 GHz, 5.9 GHz, 6 GHz and 60 GHz bands. Each frequency can be subdivided into multiple channels.

The original modulation used in 802.11 was binary amplitude-shift keying, binary frequency-shift keying, binary phase-shift keying and other schemes, such as complementary code keying. Those methods were simpler with regard to designing circuits, but they provided a limited bit rate. Newer modulation methods have emerged that provide higher data speed and reduce a network's vulnerability to interference.

Orthogonal frequency-division multiplexing (OFDM) has gained increasing prominence since the launch of 802.11a, as it expands the number of clients that can connect to a shared wireless access point. OFDM may be used in tandem with other modulation techniques, such as quadrature amplitude modulation (QAM).

802.11 specifies the use of carrier sense multiple access/collision avoidance, an algorithm that manages path sharing between two transmitting stations. The methodology is similar to IEEE's 802.3 standard for Ethernet networks, although it differs in implementation. Ethernet uses a full-duplex model for collision avoidance, where the network can listen and talk to devices at the same time. To prevent signals from colliding, Ethernet only allows a signal to be sent once acknowledgement is received that the transmission line is clear. By contrast, a Wi-Fi network uses a half-duplex model, where it can listen or speak but not do both simultaneously. Wi-Fi uses a media access protocol known as the distributed coordination function (DCF) to monitor signal traffic. If a client on the receiving end doesn't acknowledge a transmission, DCF presumes a collision has occurred and waits a given amount of time before attempting to retransmit the wireless signal.

Specific examples of IEEE 802.11 specification signal communication that can be used to send the communication signal from the messaging device may include the following:

a) 802.11 is a technology specified into two spread-spectrum methods in the 2.4 GHz band: frequency hopping and direct sequence, each at 1 Mbps or 2 Mbps, along with diffuse infrared at 1 Mbps.

b) 802.11b boosted speed to 11 Mbps using direct sequence spread spectrum (DSSS) in 2.4 GHz. It also accommodated weak signals by maintaining lower DSSS modes and emerged as the signature WLAN technology.

c) 802.11a uses an OFDM physical layer in the 5 GHz band to transmit up to 54 Mbps. The advantage of 5 GHz is it's less crowded, but the higher frequency can limit its effective signal range.

d) 802.11g uses OFDM in the 2.4 GHz band to achieve similar 54 Mbps transmission, excluding forward error correction. However, this approach also is subject to signal interference from nearby devices. 802.11g and 802.11b equipment are compatible, and vendor equipment carries both designations.

e) 802.11n, also referred to as Wi-Fi 4, marked the start of new Wi-Fi standards branding. All 802.11n wireless products support multiple input, multiple output (MIMO) technology, in which multiple transmitters and receivers are used to transfer more data at the same time. The addition of multiple antennas boosts the theoretical data rate to 450 Mbps in 2.4 GHz operation. 802.11n reportedly is backward-compatible with 802.11a, 11b and 11g networks.

f) 802.11ac, also known as Wi-Fi 5, pivots off amendments to 802.11n. Maximum data rates reach the gigabyte level in 5 GHz operation, with expanded channel width, twice the number of spatial streams, 256 QAM bandwidth increases and enhanced multiuser MIMO.

g) 802.11af enables WLAN operation in very high frequency and ultra-high frequency bands normally reserved for TV broadcast signals.

h) 802.11ah describes WLANs with low power consumption that could power extended-range hotspots or serve to handle traffic overloads on a cellular network. 802.11ah-enabled WLANs can provide an alternative to short-range Bluetooth connectivity.

i) 802.11aj, also called the Chinese Millimeter Wave frequency band, is for WLANs in China and other regions. It provides backward compatibility with 802.11ad, which is in review.

j) 802.11ax, also known as Wi-Fi 6, uses the 2.4 GHz and 5 GHz frequency bands but has the option to use 6 GHz.

k) 802.11be, also known as Wi-Fi 7, provides speeds of up to 46 gigabits per second (Gbps). Quadrature Amplitude Modulation (QAM) is a method to transmit and receive data in radio-frequency waves. The higher it is, the more information you can pack in. Wi-Fi 7 supports 4K-QAM, while Wi-Fi 6 supported 1,024-QAM, and Wi-Fi 5 was limited to 256-QAM.

It is noted that the above standards are provided for illustrative purposes only. The messaging device of the luminaire 100 can use these radio standards to transmit communications signals that indicate that the sensor 60 has detected a fire event. The messaging device 70 may transmit a WiFi signal to be received by a router that is connected to the internet for the purposes of transmitting a signal that the sensor 60 has detected a fire event.

The messaging device 70 may also use a cellular network to transmit signal. In this example, the messaging device 70 can access the internet wirelessly in providing a signal to a user that a fire has been detected by the user. Using cellular data, the messaging device 70 can access the internet wirelessly through a cellular network, allowing it to connect to the web even when not connected to a Wi-Fi network, typically using a mobile phone carrier's signal via cell towers to send and receive data.

In some embodiments, the messaging device 70 that relies upon cellular data may rely upon a signal standard, such as GSM, CDMA, UMTS (3G), LTE (4G), and 5G. CDMA (Code Division Multiple Access) uses a unique code for each user to separate signals, allowing multiple users to share the same frequency band simultaneously. GSM (Global System for Mobile Communications) employs time division multiple access (TDMA) where users take turns transmitting data within a designated time slot on a shared frequency. 2G (Second Generation) is primarily for voice calls with basic data capabilities, often using GSM or CDMA standards. The 3G (Third Generation) standard introduced faster data speeds, enabling better mobile internet browsing and streaming. The 4G (Fourth Generation) standard provides a significant improvement in data speed with (Long Term Evolution) that enable faster downloads and streaming. The 5G (Fifth Generation) standard provides further increased speeds, lower latency, and the ability to support more connected devices. Any of the aforementioned standards may be used by the messaging device 70.

The messaging device 70 can also rely upon Bluetooth or Bluetooth Low Energy (BLE) to provide wireless signal transmission. Bluetooth Low Energy (BLE) is generally combined with classic Bluetooth.

Zigbee technologies and similar standards based on the IEEE 802 network standard can be used for the messaging device 70. ZigBee can be an extension of the 802.15.4 standard.

In some embodiments, the messaging device 70 employs Z-wave. Z-Wave works by using mesh networking and low-energy radio waves to create a network of devices that can exchange information with each other. More particularly, each device in a Z-Wave network functions as a mini-router, relaying information to the next closest device until it reaches the central hub. This allows the network to extend its range without the need for repeaters or modems. Z-Wave uses a specific, low frequency (908.42 MHz in the US and Canada) that allows devices to consume less power. Z-Wave devices can exchange control commands and data with each other. For example, signal can be sent to a Z-wave messaging device from a smartphone, tablet, computer, wireless key fob, or wall-mounted panel.

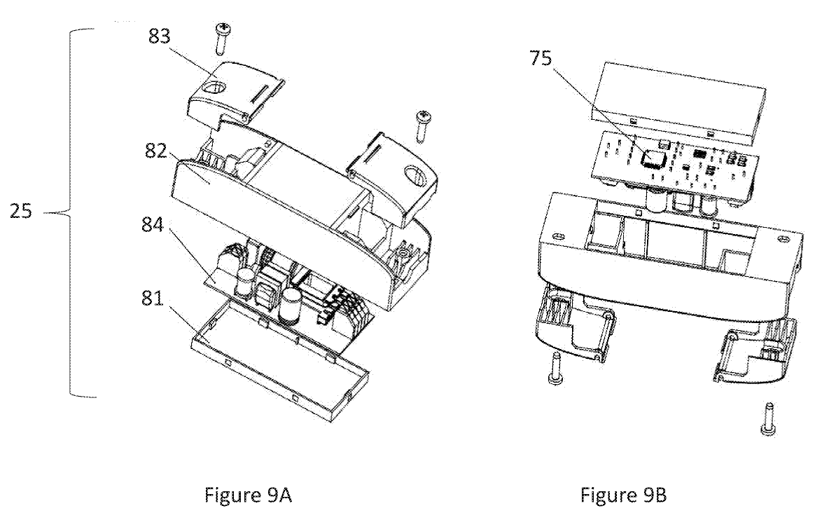

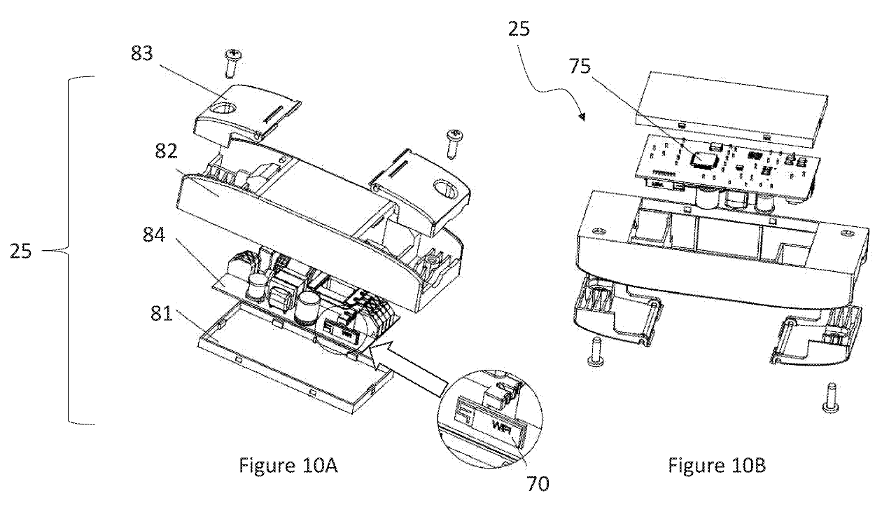

Referring to FIGS. 6B, 7B, 9B and 10B, the lighting structures also include a controller unit 75, such as a micro controller unit (MCU). In the embodiments, depicted in FIGS. 6B and 7B, the controller unit 75 may be integrated into the sensor assembly 60. In other embodiments, depicted in FIGS. 9A-10B, the controller unit 75 may be integrated into the driver electronics 25.

In some embodiments, the controller unit 75 receives data from sensor 60 and using that data makes a determination of whether a fire has been detected. In some embodiments, in response to a fire being detected, the controller unit 75 actuates the local signal emitter 90 to emit a visual and/or audible signal, as depicted in FIGS. 6A, 6B and 8. The visible alarm may be an illuminated sign and/or illuminated lights (e.g., alarm lights) that are separate from the light engine 22. The alarm lights may have a color that indicates a hazard, such as red, or the alarm lights 22 may flash or flicker. In some embodiments, in response to a fire being detected, the controller unit 75 actuates the messaging device 70 to send a message of a fire being detected to a designated user, as depicted in FIGS. 7A, 7B, 10A and 10B. In some embodiments, the controller unit 75 reading sensor readings, i.e., readings from the sensor 60 indicating a hazard, such as a fire, sends a signal to the light engine 22 causing light emitted therefrom to flicker. In some embodiments, to flicker is to flash ON and OFF.

In some embodiments, the controller unit 75 is micro controller unit (MCU). In some embodiments, the MCU can be a semiconductor IC that can include a processor unit, memory modules, communication interfaces and peripherals. The MCU can have an 8-bit architecture. The MCU can also be an ARM-based MCU, which can be a 32-bit MCU.

In some embodiments, the MCU functions by executing the program instructions stored in its non-volatile memory module. The MCU may have memory that is ROM-based. In some embodiments, the MCU can store program instructions using built-in flash memory. In some embodiments, the MCU can use RISC (Reduced Instruction Set Computer) instruction architecture for its fundamental instruction processing. To develop the program for the MCU, embedded system developers use an assembler or C programming language.

When powered up, the MCU starts executing the instruction loaded as program data. It can utilize the RAM to store run-time variables as indicated by the program. The program can include a number of instructions. For example, the program can include instructions for actuates at least one of the local signal emitters 90 to emit a visual and/or audible signal, as depicted in FIGS. 6A, 6B and 8. For example, the program can include instructions for employing the messaging device 70 to send a message of a fire being detected to a designated user, as depicted in FIGS. 7A, 7B, 10A and 10B.

Referring to FIGS. 2, 4, 9 and 9A-10B, the lighting structure 100 includes driver electronics 25 that regulates the power supply to the light engine 22, e.g., LED board. The driver electronics 25 are in a housing 801, 802, 803 that is separate from the housing 50 of the light structure 100 containing the light engine 22. In some embodiments, the housing for the driver electronics includes a bottom case 81, top case 82, and a cover 83. A driver electronics board 84 for the driver electronics 25 is contained within the aforementioned housing components. The driver electronics board 84 may be a printed circuit board that includes a mixing circuit for controlling current to the different strings 56a, 56b of LEDs 55a, 55b of the light engine 22. In some embodiments, the driver electronics board 84 may also include a controller unit 75 and/or messaging device 70 present thereon. In some embodiments, the driver electronics 25 are electrically connected to the light engine 22 contained within the housing 50 through a cable 26.

In some embodiments, the driver electronics 25 provides the connection point for a main power connection from the power source to the lighting structure 100. For example, the main power wire may provide to the downlight a universal input voltage, e.g., a voltage ranging from 120V to 277V. In some further examples, the main power wire may provide an input voltage of 347V. An input voltage of 120-277V can be suitable for commercial applications. In some embodiments, the input voltage can be 120V, which can be suitable for both residential and commercial applications. In addition to the main power wire, the driver electronics 25 also include a connection for dimming controls, i.e., dimming wire connection. In some embodiments, the lighting structure 100 described herein may have a diming wire that provides for 0-10V and phase dimmable applications. The driver electronics 25 may also provide power to the sensor 60 through the sensor power cable 61.

In some embodiments, the driver electronics 25 include a current mixing circuit for controlling a mixture ratio of the at least two stings of LEDs within the light engine 22 to provide light emission of a selected lighting characteristic, such as color correlated temperature (CCT). The different LED strings 56a, 56b, may each be sent a separate current level. Each of the different lighting schemes is connected to a separate channel on the multi-channel electronics driver. In this example, the mixture ratio is referring to sending different levels of current to the different light schemes. By adjusting current to each of the light schemes the contribution of the individual light schemes color correlated temperature may be modulated to adjust the characteristics of the light emission by the combined light from the different LED strings 56a, 56b. The function of the mixing circuit to control current to the different LED strings 56a, 56b is controlled through the controller 75.

The controller 75 may have additional functions than the detection of fire through the sensor 60, the generation of signals from the local signal emitter 90 and/or employing the messaging device 70 to generate communications indicating that a fire had been detected by the sensor 60. For example, the controller 75 may be in communication, e.g., through the messaging device 70, with an interface through which a user can adjust lighting characteristics for light being emitted by the light engine 22 of the lighting structure 100.

The lighting structures 100 depicted in FIGS. 1-10B may be used in a method of lighting that includes mounting a housing 50 of fire-retardant material containing a light engine 22 of a light structure 100 to an opening in a ceiling 101. The method may then monitor an environment under the ceiling 101 with a sensor 60 within the housing 50 containing the light engine 22. The housing 50 may have the geometry of a downlight. In some embodiments, the controller 75 may analyze measurements from the sensor 60 to detect the incidence of a fire.

The method may then continue sending a message with a message device 70 within the light structure 100 to a user reporting the measurements from the sensor 60 that detected the fire. The messaging device 70 may include a WiFi transceiver, a cellular transceiver, a Zigbee transceiver, a Bluetooth transceiver or a combination thereof. The messaging device 70 is mounted within the housing 50 of fire-retardant material. In some embodiments, the messaging device 70 is mounted within driver electronics 25 that are separate from the housing 50 of fire-retardant material.

The message device 70 may send the message of the fire being detected by the sensor 60 to a user. The user may read the message from the messaging device 70 on a console, which can be provided by a mobile computing device, a laptop / notebook computer, a subnotebook, a tablet, a phablet computer, a mobile phone, a smartphone, a personal digital assistant (PDA), a portable media player (PMP), a mobile phone, handheld gaming device, gaming platform, portable computing device, body-worn computing device, smart watch, smart glasses, smart headgear, or a combination thereof.

In some embodiments, the method may further include emitting a local signal with an emitter 90 mounted in the housing 50 of fire-retardant material in response to the measurements from the sensor 60 that detected the fire. In some embodiments, the local signal emitted by the emitter 90 an audible sound, such as a buzzer and/or alarm, or a visual que, such as flashing lights.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A lighting structure comprising:
a light engine contained within a housing, there the housing is comprised of a fire-retardant material; and
a fire sensor assembly mounted within the housing, the fire sensor assembly comprising a sensor and a message sending device.

2. The lighting structure of claim 1, wherein the housing has a downlight geometry.

3. The lighting structure of claim 1 wherein the fire-retardant material comprises stainless steel or cold rolled steel.

4. The lighting structure of claim 1, wherein the fire-retardant material has a melting temperature that is greater than 1350°C.

5. The lighting structure of claim 1, wherein the fire sensor assembly includes
a sensor and a control unit, wherein the control unit reading sensor readings indicating a fire sends a signal to the light engine causing light emitted therefrom to flicker.

6. The light structure of claim 1, wherein the sensor of the fire sensor assembly is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

7. The lighting structure of claim 1, wherein the message sending device comprises a WiFi transceiver, a cellular transceiver, a Zigbee transceiver, a Bluetooth transceiver or a combination thereof.

8. The lighting structure of claim 1, further comprising a local signal emitter mounted in the fire sensory assembly, wherein the local signal emitter comprises an audible sound or a visual que.

9. A lighting structure comprising:
a light engine contained within a housing, there the housing is comprised of a fire-retardant material;
a fire sensor mounted within the housing; and
driver electronics electrically connected to the light engine but separate from the housing, the driver electronics including a message sending device.

10. The lighting structure of claim 9, wherein the fire-retardant material comprises stainless steel or cold rolled steel.

11. The light structure of claim 9, wherein the fire sensor is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

12. The lighting structure of claim 9, wherein the message sending device comprises a WiFi transceiver, a cellular transceiver, a Zigbee transceiver, a Bluetooth transceiver or a combination thereof.

13. The lighting structure of claim 10, further comprising a local signal emitter mounted in the housing for the light engine.

14. A method of lighting comprising:
mounting a housing of fire-retardant material containing a light engine of a light structure to an opening in a ceiling;
monitoring an environment under the ceiling with a sensor within the housing containing the light engine;
analyzing measurements from the sensor to detect fire; and
sending a message with a message device within the light structure to a user reporting the measurements from the sensor that detected the fire.

15. The method of claim 14, wherein the sensor is selected from the group consisting of dispersive infrared sensors, non-dispersive infrared sensors, electrochemical sensors, catalytic combustible gas sensors, pyroelectric infrared sensors, thermopile infrared sensors, semiconductor flammable gas sensors, photoelectric sensors, cameras, pyroelectric infrared sensors, thermopile infrared sensors, semiconductor flammable gas sensors, photoelectric sensors, temperature sensors and combinations thereof.

16. The method of claim 14, wherein the messaging device comprises a WiFi transceiver, a cellular transceiver, a Zigbee transceiver, a Bluetooth transceiver, a Z-wave transceiver or a combination thereof.

17. The method of claim 14, wherein the messaging device is mounted within the housing of fire-retardant material.

18. The method of claim 14, wherein the messaging device is mounted within driver electronics that are separate from the housing of fire-retardant material.

19. The method of claim 14, further comprising emitting a local signal with an emitter mounted in the housing of fire-retardant material in response to the measurements from the sensor that detected the fire.

20. The method of claim 14, wherein the local signal comprises an audible sound or a visual que.
